(19) United States
(12) Patent Application Publication
(10) Pub. No.: US 2015/0340968 A1
(43) Pub. Date: Nov. 26, 2015

(54) MEMS STRUCTURE, ELECTRONIC APPARATUS, AND MOVING OBJECT

(71) Applicant: Seiko Epson Corporation, Tokyo (JP)

(72) Inventors: Shogo INABA, Shiojiri (JP); Akihiko EBINA, Fujimi (JP)

(21) Appl. No.: 14/700,756

(22) Filed: Apr. 30, 2015

(30) Foreign Application Priority Data
May 26, 2014 (JP) 2014-108378

(51) Int. Cl. H02N 1/00

(52) U.S. Cl. CPC H02N 1/006

(57) ABSTRACT

A MEMS structure includes: a substrate; a lower electrode disposed on the substrate; an upper electrode including a movable portion disposed facing and spaced from the lower electrode; and a reinforcing portion disposed in the upper electrode so as to extend along an extending direction of the movable portion, the reinforcing portion being composed of a material having a higher Young's modulus than the upper electrode.

### BACKGROUND

1. Technical Field

The present invention relates to a MEMS structure, an electronic apparatus, and a moving object.

2. Related Art

MEMS structures manufactured using a MEMS (Micro Electro Mechanical System) technique are applied to various structures (e.g., vibrators, filters, sensors, motors, etc.) having a movable portion.

For example, a MEMS acceleration sensor disclosed in JP-A-2009-276305 includes a sensor housing frame, a circular disc-shaped movable weight disposed in the frame of the sensor housing frame, and plate springs connecting the periphery of the movable weight with the inner wall surface of a sensor frame body, all of which are integrally formed of silicon. Moreover, the MEMS acceleration sensor includes an upper capacitor electrode and a lower capacitor electrode that are disposed facing each other via the movable weight. In the MEMS acceleration sensor, the movable weight is displaced in response to the motion of a measuring object, and with the displacement, an electrostatic capacitance between the upper capacitor electrode and the lower capacitor electrode changes. Hence, based on the electrostatic capacitance between the upper capacitor electrode and the lower capacitor electrode, the acceleration of the measuring object can be measured.

In the MEMS acceleration sensor disclosed in JP-A-2009-276305, the mass of the movable weight is increased by filling a hole penetrating the center of the movable weight in the thickness direction with a high-density member such as gold-germanium for the purpose of reducing noise due to gas molecules colliding with the movable weight.

In the MEMS acceleration sensor disclosed in JP-A-2009-276305, however, since the high-density member is locally provided only at the center of the movable weight, there is a problem of deterioration of frequency characteristics due to, for example, the frequency of an unwanted vibration mode being close to the frequency of a fundamental vibration mode.

### SUMMARY

An advantage of some aspects of the invention is to provide a MEMS structure having excellent frequency characteristics, and provide an electronic apparatus and a moving object each including the MEMS structure.

The advantage can be achieved by the following application examples of the invention.

### Application Example 1

A MEMS structure according to this application example of the invention includes: a substrate; a fixed electrode disposed above the substrate; a movable electrode including a movable portion disposed facing and spaced from the fixed electrode; and a reinforcing portion disposed in the movable electrode so as to extend along an extending direction of the movable portion, the reinforcing portion including a material having a higher Young's modulus than the movable electrode.

According to the MEMS structure, since the movable electrode is reinforced by the reinforcing portion, the rigidity of the movable electrode can be increased. Therefore, the frequency of an unwanted vibration mode of the movable portion can be moved away from the frequency of a fundamental vibration mode (normal vibration mode), or the frequency of the movable portion can be adjusted. As a result, it is possible to provide the MEMS structure having excellent frequency characteristics.

### Application Example 2

In the MEMS structure according to the application example of the invention, it is preferable that the reinforcing portion includes a portion extending along a width direction of the movable portion.

With this configuration, the frequency of a spurious vibration mode of the movable portion can be effectively moved away from the frequency of the fundamental vibration mode.

### Application Example 3

In the MEMS structure according to the application example of the invention, it is preferable that the movable electrode includes a fixed portion connected to the movable portion and fixed to the substrate, and that the reinforcing portion includes a portion extending along a direction in which the movable portion and the fixed portion are arranged in parallel in a plan view.

With this configuration, by increasing an allowable input voltage or, for example, increasing the spring constant (spring force of the movable portion) of a vibrating system including the movable portion supported in a cantilever fashion to the fixed portion, it is possible to increase the frequency of the fundamental vibration mode or reduce the sticking of the movable electrode to the fixed electrode.

### Application Example 4

In the MEMS structure according to the application example of the invention, it is preferable that the movable electrode includes a fixed portion connected to the movable portion and fixed on the substrate, and that the reinforcing portion includes a portion disposed so as to connect the movable portion with the fixed portion.

With this configuration, it is possible, for example, to effectively increase the spring constant of the vibrating system including the movable portion supported in a cantilever fashion to the fixed portion.

### Application Example 5

In the MEMS structure according to the application example of the invention, it is preferable that the reinforcing portion includes a metal.

With this configuration, the conductivity of the movable electrode can be made excellent, and the electrical characteristics of the movable electrode can be made excellent. Moreover, the reinforcing portion can be formed simply and highly accurately by deposition. While the movable electrode is generally formed using silicon, many metals have greater specific gravities than silicon. Therefore, the reinforcing portion is composed of a metal, whereby the mass of the vibrating system including the movable portion is increased, and the movable portion can be downsized or the frequency of the vibrating system can be lowered.

### Application Example 6

In the MEMS structure according to the application example of the invention, it is preferable that the metal includes tungsten.

Tungsten has an extremely high hardness (Young's modulus). Therefore, the movable electrode can be effectively (efficiently) reinforced by the reinforcing portion.

### Application Example 7

In the MEMS structure according to the application example of the invention, it is preferable that the reinforcing portion penetrates the movable electrode in a thickness direction thereof.

With this configuration, the reinforcing portion can be formed simply and highly accurately in the movable electrode. Moreover, it is possible to prevent or reduce the deflection of the movable electrode because of a difference in thermal expansion coefficient between the reinforcing portion and the movable electrode.

### Application Example 8

In the MEMS structure according to the application example of the invention, it is preferable that the reinforcing portion is disposed on each of both surfaces of the movable electrode.

With this configuration, the reinforcing portion can be symmetrically disposed in the thickness direction of the movable electrode. Therefore, it is possible to prevent or reduce the deflection of the movable electrode because of a difference in thermal expansion coefficient between the reinforcing portion and the movable electrode. Moreover, the resonant frequency of the vibrating system including the movable portion can be relatively simply adjusted by removing a portion of the reinforcing portion as necessary by a laser or the like.

### Application Example 9

In the MEMS structure according to the application example of the invention, it is preferable that the number of the movable portions is more than one.

With this configuration, vibration leakage from the movable portions to the outside can be reduced.

### Application Example 10

An electronic apparatus according to this application example of the invention includes the MEMS structure according to the application example of the invention.

With this configuration, it is possible to provide the electronic apparatus including the MEMS structure having excellent frequency characteristics.

### Application Example 11

A moving object according to this application example of the invention includes the MEMS structure according to the application example of the invention.

With this configuration, it is possible to provide the moving object including the MEMS structure having excellent frequency characteristics.

### BRIEF DESCRIPTION OF THE DRAWINGS

The invention will be described with reference to the accompanying drawings, wherein like numbers reference like elements.

FIG. 1 is a cross-sectional view showing a MEMS structure according to a first embodiment of the invention.

FIGS. 2A and 2B show a vibrating element included in the MEMS structure shown in FIG. 1, in which FIG. 2A is a cross-sectional view, and FIG. 2B is a plan view.

FIGS. 3A to 3E show a manufacturing step (fixed electrode forming step) of the MEMS structure shown in FIG. 1.

FIGS. 4A to 4E show a manufacturing step (movable electrode forming step) of the MEMS structure shown in FIG. 1.

FIGS. 5A to 5C show a manufacturing step (cavity forming step) of the MEMS structure shown in FIG. 1.

FIGS. 6A and 6B show a vibrating element included in a MEMS structure according to a second embodiment of the invention, in which FIG. 6A is a cross-sectional view, and FIG. 6B is a plan view.

FIGS. 7A and 7B show a vibrating element included in a MEMS structure according to a third embodiment of the invention, in which FIG. 7A is a cross-sectional view, and FIG. 7B is a plan view.

FIG. 8 is a cross-sectional view showing a MEMS structure according to a fourth embodiment of the invention.

FIG. 9 is a perspective view showing a configuration of a mobile (or notebook) personal computer as a first example of an electronic apparatus according to the invention.

FIG. 10 is a perspective view showing a configuration of a mobile phone (including a PHS) as a second example of the electronic apparatus according to the invention.

FIG. 11 is a perspective view showing a configuration of a digital still camera as a third example of the electronic apparatus according to the invention.

FIG. 12 is a perspective view showing a configuration of an automobile as an example of a moving object according to the invention.

### DESCRIPTION OF EXEMPLARY EMBODIMENTS

Hereinafter, a MEMS structure, an electronic apparatus, and a moving object according to the invention will be described in detail based on embodiments shown in the accompanying drawings.

### First Embodiment

### 1. MEMS Structure

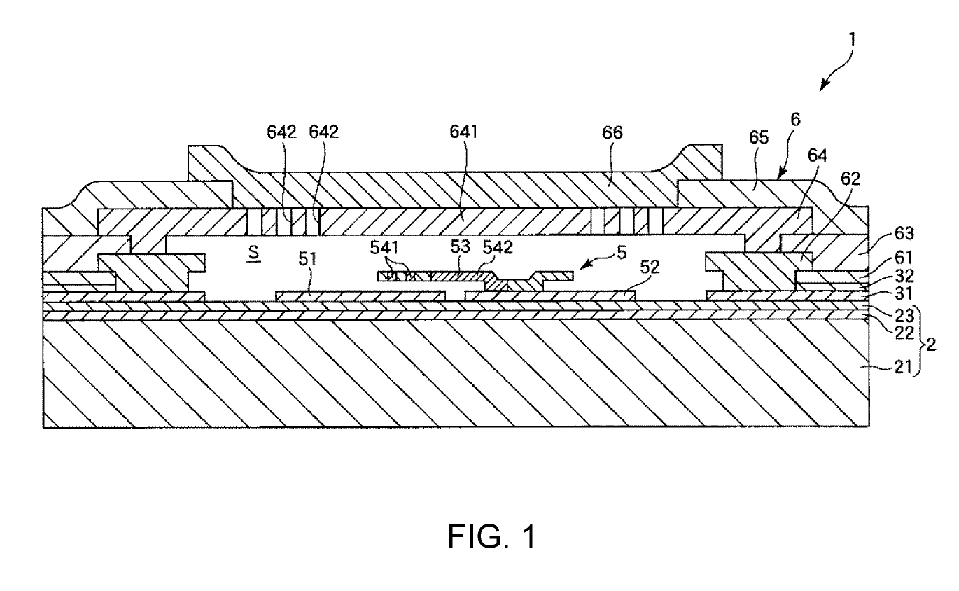

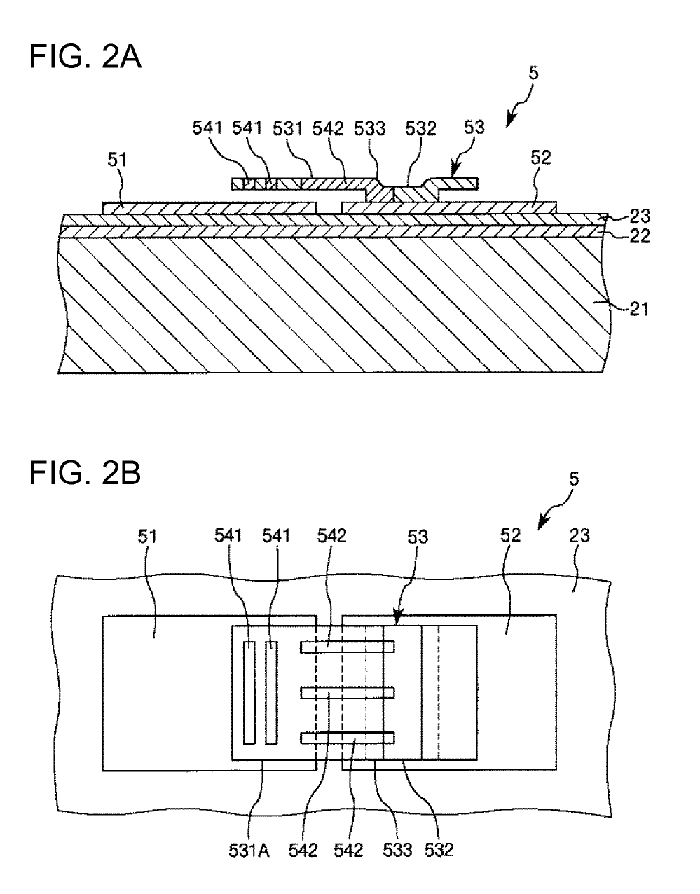

FIG. 1 is a cross-sectional view showing a MEMS structure according to a first embodiment of the invention. FIGS. 2A and 2B show a vibrating element included in the MEMS structure shown in FIG. 1, in which FIG. 2A is a cross-sectional view, and FIG. 2B is a plan view.

The MEMS structure 1 shown in FIG. 1 includes a substrate 2 (base), a vibrating element 5 disposed on the substrate 2, and a stacked structure 6 forming a cavity S that accommodates the vibrating element 5 relative to the substrate 2. In the embodiment, in addition to the vibrating element 5, a conductor layer 31 is disposed on a surface of the substrate 2 on the vibrating element 5 side. Moreover, an insulating layer 32 is disposed between the substrate 2 and the stacked structure 6. These parts will be sequentially described below.

### Substrate 2

The substrate 2 includes a semiconductor substrate 21, an insulating film 22 provided on one of surfaces of the semiconductor substrate 21, and an insulating film 23 provided on a surface of the insulating film 22 on the side opposite to the semiconductor substrate 21.

The semiconductor substrate 21 is composed of semiconductor such as silicon. The semiconductor substrate 21 is not limited to a substrate composed of a single material, such as a silicon substrate, and may be, for example, a substrate having a stacked structure, such as an SOI substrate.

The insulating film 22 is, for example, a silicon oxide film, and has an insulating property. The insulating film 23 is, for example, a silicon nitride film, and has an insulating property and resistance to an etchant containing hydrofluoric acid. Here, since the insulating film 22 (silicon oxide film) is present between the semiconductor substrate 21 (silicon substrate) and the insulating film 23 (silicon nitride film), the transfer of stress occurring in deposition of the insulating film 23 to the semiconductor substrate 21 can be mitigated with the insulating film 22. Moreover, the insulating film 22 can be used also as an element isolation film when a semiconductor circuit is formed on and above the semiconductor substrate 21. The insulating films 22 and 23 are not limited to the constituent materials described above, and one of the insulating films 22 and 23 may be omitted as necessary.

The conductor layer 31 patterned is disposed on the insulating film 23 of the substrate 2. The conductor layer is configured by, for example, doping (diffusion or implantation) monocrystalline silicon, polycrystalline silicon (polysilicon), or amorphous silicon with an impurity such as phosphorus or boron, and has conductivity. Although not shown in the drawing, the conductor layer 31 is patterned so as to have a first portion that constitutes a wire electrically connected to the vibrating element 5, and a second portion that is spaced and electrically insulated from the first portion.

The insulating layer 32 is disposed on the conductor layer 31. The insulating layer 32 is, for example, a silicon oxide film. The insulating layer 32 may be omitted.

### Vibrating Element 5

As shown in FIGS. 2A and 2B, the vibrating element 5 includes a pair of lower electrodes 51 and 52 disposed on the insulating film 23 of the substrate 2 and an upper electrode 53 supported to the lower electrode 52.

The lower electrodes 51 and 52 each have a plate-like or sheet-like shape along the substrate 2, and are disposed spaced from each other. Although not shown in the drawings, the lower electrodes 51 and 52 are electrically connected to the above-described wire included in the conductor layer 31. Here, the lower electrode 51 constitutes a “fixed electrode”. The lower electrode 52 can be omitted. In this case, the upper electrode 53 is directly fixed to the insulating film 23.

The upper electrode 53 includes a plate-like or sheet-like movable portion 531 facing and spaced from the lower electrode 51, a fixed portion 532 fixed to the lower electrode 52, and a coupling portion 533 coupling the movable portion 531 with the fixed portion 532. The upper electrode 53 is electrically connected to the lower electrode 52. Here, the upper electrode 53 constitutes a “movable electrode”.

Each of the lower electrodes 51 and 52 and the upper electrode 53 is configured by doping (diffusion or implantation) monocrystalline silicon, polycrystalline silicon (polysilicon), or amorphous silicon with an impurity such as phosphorus or boron, and has conductivity.

The film thickness of each of the lower electrodes 51 and 52 is not particularly limited, but can be set to, for example, from 0.1 μm to 1.0 μm. The film thickness of the upper electrode 53 is not particularly limited, but can be set to, for example, from 0.1 μm to 1.0 μm.

A plurality of reinforcing portions 541 and a plurality of reinforcing portions 542 are disposed in the upper electrode 53 (movable electrode) included in the vibrating element 5. The reinforcing portions 541 and 542 have a function of reinforcing the upper electrode 53. With this configuration, the frequency characteristics of the MEMS structure 1 can be made excellent by reducing an unwanted vibration of the upper electrode 53 or adjusting the resonant frequency of the upper electrode 53. The reinforcing portions 541 and 542 will be described in detail later.

### Stacked Structure 6

The stacked structure 6 is formed so as to define the cavity S accommodating the vibrating element 5. The stacked structure 6 includes: an inter-layer insulating film 61 formed on the substrate 2 so as to surround the vibrating element 5 in a plan view; a wiring layer 62 formed on the inter-layer insulating film 61; an inter-layer insulating film 63 formed on the wiring layer 62 and the inter-layer insulating film 61; a wiring layer 64 formed on the inter-layer insulating film 63 and including a covering layer 641 in which a plurality of fine pores 642 (opening holes) are formed; a surface protective film 65 formed on the wiring layer 64 and the inter-layer insulating film 63; and a sealing layer 66 provided on the covering layer 641.

Each of the inter-layer insulating films 61 and 63 is, for example, a silicon oxide film. Each of the wiring layers 62 and 64 and the sealing layer 66 is composed of a metal such as aluminum. The surface protective film 65 is, for example, a silicon nitride film.

On and above the semiconductor substrate 21, a semiconductor circuit may be fabricated other than the configurations described above. The semiconductor circuit includes active elements, such as MOS transistors, and other circuit elements formed as necessary, such as capacitors, inductors, resistors, diodes, and wires (including the wire connected to the lower electrode 51, the wire connected to the upper electrode 53, and the wiring layers 62 and 64). Although not shown in the drawings, the above-described wire electrically connected to the vibrating element 5 is disposed so as to connect the inside and outside of the cavity S between the wiring layer 62 and the insulating film 23, and the wiring layer 62 is formed so as to be spaced from the wire.

The cavity S defined by the substrate 2 and the stacked structure 6 functions as a containing portion that contains the vibrating element 5. Moreover, the cavity S is a hermetically sealed space. In the embodiment, the cavity S is in a vacuum state (300 Pa or less). With this configuration, the vibration characteristics of the vibrating element 5 can be made excellent. However, the cavity S may not be in the vacuum state, and may be in an atmospheric pressure, a reduced-pressure state where the air pressure is lower than the atmospheric pressure, or a pressurized state where the air pressure is higher than the atmospheric pressure. Moreover, an inert gas such as nitrogen gas or noble gas may be sealed in the cavity S.

The configuration of the MEMS structure 1 has been briefly described above.

In the MEMS structure 1 configured as described above, with the application of a periodically changing voltage between the lower electrode 51 and the upper electrode 53, the movable portion 531 flexurally vibrates while being displaced alternately in directions toward and away from the lower electrode 51. As described above, the MEMS structure 1 can be used as an electrostatically driven vibrator in which the movable portion 531 is vibrated by generating a periodically changing electric field between the lower electrode 51 and the movable portion 531.

The MEMS structure 1 can be used as an oscillator to extract a signal at a predetermined frequency by, for example, combining with an oscillation circuit (driver circuit). The oscillation circuit can be provided as a semiconductor circuit on the substrate 2. Moreover, the MEMS structure 1 can also be applied to various types of sensors such as gyro sensors, pressure sensors, acceleration sensors, and inclination sensors.

### Reinforcing Portion

Here, the reinforcing portions 541 and 542 will be described in detail.

As shown in FIGS. 2A and 2B, the plurality (two in the embodiment) of reinforcing portions 541 and the plurality (three in the embodiment) of reinforcing portions 542 are disposed in the upper electrode 53 of the vibrating element 5. In the embodiment, each of the reinforcing portions 541 and 542 penetrates the upper electrode 53 in a thickness direction thereof.

Particularly, the reinforcing portions 541 and the reinforcing portions 542 are disposed in the upper electrode 53 so as to extend respectively along extending directions of the sheet-like movable portion 531.

Specifically, the plurality of reinforcing portions 541 are disposed at a portion of the movable portion 531, which is supported in a cantilever fashion to the fixed portion 532, on a free end side. When viewed from a direction in which the lower electrode 51 and the movable portion 531 are arranged in parallel (hereinafter also referred to as “plan view”), the plurality of reinforcing portions 541 are arranged in parallel along a direction (hereinafter also referred to as “length direction”) connecting the fixed and free ends of the movable portion 531. Moreover, each of the plurality of reinforcing portions 541 extends along a direction (hereinafter also referred to as “width direction”) vertical to the direction in which the fixed and free ends of the movable portion 531 are arranged in parallel in the plan view.

Each of the plurality of reinforcing portions 542 is disposed, on the fixed portion 532 side relative to a group formed of the plurality of reinforcing portions 541, so as to connect the movable portion 531 with the fixed portion 532. The plurality of reinforcing portions 542 are arranged in parallel along the width direction of the movable portion 531 in the plan view. Moreover, each of the plurality of reinforcing portions 542 extends along the length direction of the movable portion 531.

Each of the reinforcing portions 541 and 542 disposed as described above is composed of a material having a higher Young's modulus than the upper electrode 53.

The reinforcing portions 541 and 542 have the function of reinforcing the upper electrode 53. With this configuration, the rigidity of the upper electrode 53 can be increased. Therefore, the frequency of an unwanted vibration mode of the movable portion 531 can be moved away from the frequency of a fundamental vibration mode (normal vibration mode), or the frequency of the movable portion 531 can be adjusted. As a result, it is possible to provide the MEMS structure 1 having excellent frequency characteristics.

Here, since the reinforcing portions 541 extend along the width direction of the movable portion 531, torsion about an axis along the length direction of the movable portion 531 is reduced, so that the frequency of a spurious vibration mode of the movable portion 531 can be effectively moved away from the frequency of the fundamental vibration mode. Moreover, in the embodiment, since the reinforcing portions 541 are disposed at the portion on the free end side of the movable portion 531, the mass of the reinforcing portion 541 greatly affects the mass of a vibrating system. Therefore, by increasing the mass of the reinforcing portion 541, it is possible to effectively reduce the resonant frequency of the vibrating system or reduce the dimension of the movable portion 531 in the length direction.

Moreover, the reinforcing portions 542 extend along the direction in which the movable portion 531 and the fixed portion 532 connected to the movable portion 531 and fixed to the substrate 2 are arranged in parallel. Therefore, by increasing an allowable input voltage or increasing the spring constant (spring force of the movable portion 531) of the vibrating system including the movable portion 531 supported in a cantilever fashion to the fixed portion 532, it is possible to increase the frequency of the fundamental vibration mode or reduce the sticking of the upper electrode 53 to the lower electrode 51.

Moreover, the reinforcing portions 542 are disposed so as to connect the movable portion 531 with the fixed portion 532. Therefore, it is possible to effectively increase the spring constant of the vibrating system including the movable portion 531 supported in a cantilever fashion to the fixed portion 532. This is because a closer portion of the movable portion 531 to the fixed portion 532 makes a contribution as a spring of the vibrating system. Moreover, in the embodiment, the ends of the reinforcing portions 542 on the fixed portion 532 side are in contact with the lower electrode 52. With this configuration, the reinforcing portions 542 are strongly joined to the lower electrode 52, and the fixed portion 532 can be stably fixed to the lower electrode 52. As a result, the reliability of the MEMS structure 1 can be increased.

Moreover, since the reinforcing portions 541 and 542 penetrate the upper electrode 53 in the thickness direction thereof, the reinforcing portions 541 and 542 can be formed simply and highly accurately in the upper electrode 53 using a semiconductor manufacturing process or a process similar thereto, as will be described in detail later. Moreover, the reinforcing portions 541 and 542 include portions respectively present on one side and the other side of the upper electrode 53 in the thickness direction thereof. Therefore, it is possible to prevent or reduce the deflection of the upper electrode 53 because of a difference in thermal expansion coefficient between the reinforcing portions 541 and 542 and the upper electrode 53.

The length of the reinforcing portion 541 is not particularly limited, but is preferably within a range from 0.6 to 1 with respect to the width of the movable portion 531 and more preferably within a range from 0.7 to 0.9. With this configuration, the frequency of the spurious vibration mode of the movable portion 531 can be effectively moved away from the frequency of the fundamental vibration mode.

The length of the reinforcing portion 542 is not particularly limited, but is preferably within a range from 0.1 to 1.5 with respect to the length of the movable portion 531. With this configuration, the reinforcing portion 542 can be disposed so as to connect the movable portion 531 with the fixed portion 532 while preventing the reinforcing portion 542 from becoming larger than necessary.

The width of each of the reinforcing portions 541 and 542 is not particularly limited, but is, for example, preferably within a range from 0.1 to 3 with respect to the thickness of the movable portion 531. With this configuration, the vibration characteristics of the movable portion 531 can be made excellent while making it easy to form the reinforcing portions 541 and 542.

Moreover, although the width of each of the reinforcing portions 541 and 542 is constant over the entire region of the upper electrode 53 in the thickness direction in the illustration, each of the reinforcing portions 541 and 542 may include a portion having a different width. For example, the width of each of the reinforcing portions 541 and 542 may be continuously or discontinuously widened from one surface side toward the other surface side of the upper electrode 53.

The thickness of the reinforcing portions 541 and 542 is the same as the thickness of the upper electrode 53 in the illustration, but may be smaller or larger than the thickness of the upper electrode 53. When the thickness of the reinforcing portions 541 and 542 is larger than the thickness of the upper electrode 53, a portion of each of the reinforcing portions 541 and 542 projects from one of both surfaces of the upper electrode 53. When a portion of the reinforcing portions 541 and 542 projects from the surface of the upper electrode 53 on the lower electrode 51 side, the projecting portion provides a function of preventing the sticking of the upper electrode 53 to the lower electrode 51.

A material constituting the reinforcing portions 541 and 542 is not particularly limited as long as the material has a higher Young's modulus than a material (for example, silicon) constituting the upper electrode 53. For example, a metal, a ceramic, or the like can be used, but a metal is preferably used. With this configuration, the conductivity of the upper electrode 53 can be made excellent, and the electrical characteristics of the upper electrode 53 can be made excellent. Moreover, the reinforcing portions 541 and 542 can be formed simply and highly accurately by deposition. While the upper electrode 53 is generally formed using silicon, many metals have greater specific gravities than silicon. Therefore, the reinforcing portions 541 and 542 are composed of a metal (material having a greater specific gravity than the material constituting the upper electrode 53), whereby the mass of the vibrating system including the movable portion 531 is increased, and the movable portion 531 can be downsized or the frequency of the vibrating system can be lowered.

A metal used as the constituent material of the reinforcing portions 541 and 542 is not particularly limited. For example, examples of the metal include gold, platinum, iridium, copper, nickel, tungsten, tantalum, and an alloy containing at least one kind of them, but tungsten or a tungsten alloy is preferably used. Tungsten has an extremely high hardness (Young's modulus). Therefore, the upper electrode can be effectively (efficiently) reinforced by the reinforcing portion. Moreover, tungsten is easily deposited and has a high affinity for a semiconductor manufacturing process.

### Method of Manufacturing MEMS Structure

Next, a method of manufacturing the MEMS structure 1 will be briefly described.

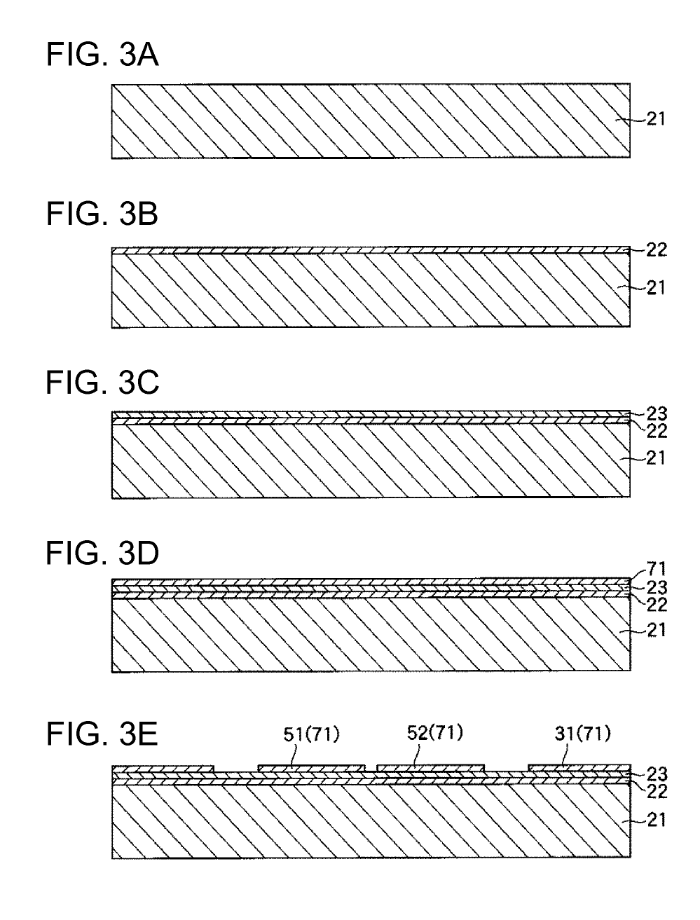

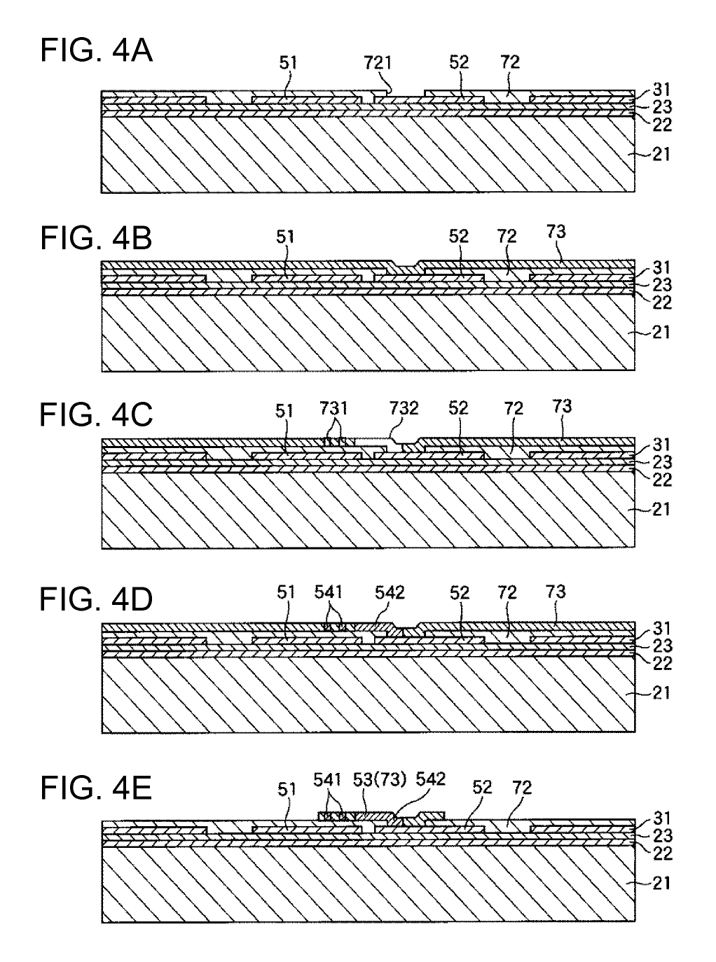

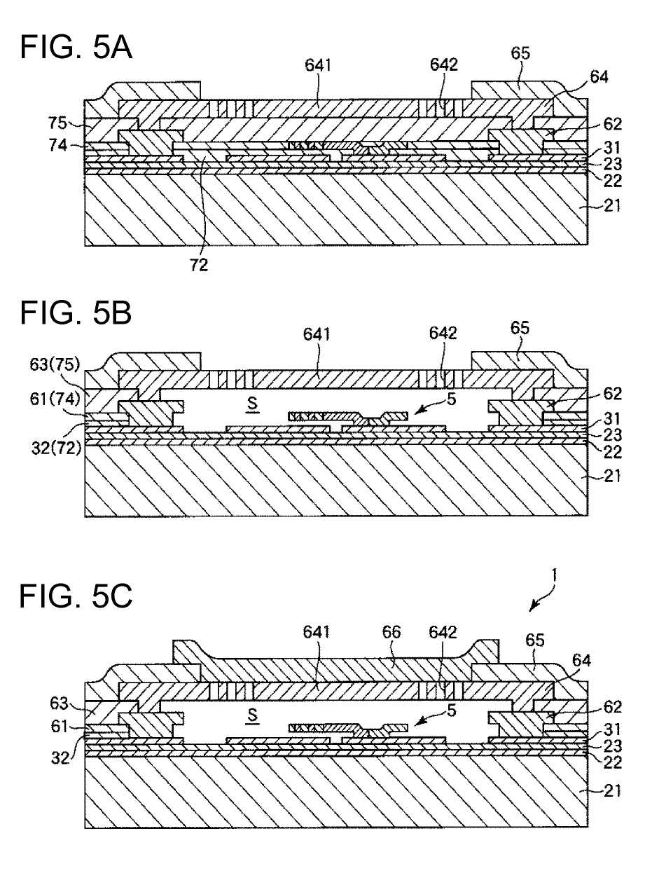

FIGS. 3A to 3E show a manufacturing step (fixed electrode forming step) of the MEMS structure shown in FIG. 1; FIGS. 4A to 4E show a manufacturing step (movable electrode forming step) of the MEMS structure shown in FIG. 1; and FIGS. 5A to 5C show a manufacturing step (cavity forming step) of the MEMS structure shown in FIG. 1. The manufacturing method will be described below based on the drawings.

### Vibrating Element Forming Step

### Step of Preparing Substrate

First, as shown in FIG. 3A, the semiconductor substrate 21 (silicon substrate) is prepared.

When a semiconductor circuit is formed on and above the semiconductor substrate 21, a source and a drain of a MOS transistor of the semiconductor circuit are formed by ion doping at a portion in which the insulating film 22 and the insulating film 23 are not formed in an upper surface of the semiconductor substrate 21.

Next, as shown in FIG. 3B, the insulating film 22 (silicon oxide film) is formed on the upper surface of the semiconductor substrate 21.

A forming method of the insulating film 22 (silicon oxide film) is not particularly limited, and, for example, a thermal oxidation method (including a LOCOS method and an STI method), a sputtering method, a CVD method, or the like can be used. The insulating film 22 may be patterned as necessary, and when, for example, a semiconductor circuit is formed on and above the upper surface of the semiconductor substrate 21, the insulating film 22 is patterned so as to expose a portion of the upper surface of the semiconductor substrate 21.

Thereafter, as shown in FIG. 3C, the insulating film 23 (silicon nitride film) is formed on the insulating film 22.

A forming method of the insulating film 23 (silicon nitride film) is not particularly limited, and, for example, a sputtering method, a CVD method, or the like can be used. The insulating film 23 may be patterned as necessary, and when, for example, a semiconductor circuit is formed on and above the upper surface of the semiconductor substrate 21, the insulating film 23 is patterned so as to expose a portion of the upper surface of the semiconductor substrate 21.

### Step of Forming Fixed Electrode Forming Film

Next, as shown in FIG. 3D, a conductor film 71 (fixed electrode forming film) for forming the conductor layer 31 and the lower electrodes 51 and 52 is formed on the insulating film 23.

Specifically, for example, a silicon film composed of polycrystalline silicon or amorphous silicon is formed on the insulating film 23 by a sputtering method, a CVD method, or the like, and thereafter, the silicon film is doped with an impurity such as phosphorus to thereby form the conductor film 71. Depending on the configuration of the insulating film 23, an epitaxially grown silicon film may be doped with an impurity such as phosphorus to thereby form the conductor film 71.

Next, the conductor film 71 is patterned to form the conductor layer 31 and the lower electrodes 51 and 52 as shown in FIG. 3E.

Specifically, for example, a photoresist is applied on the conductor film 71 and patterned into the shapes (plan-view shapes) of the conductor layer 31 and the lower electrodes 51 and 52 to form a photoresist film. Then, the conductor film 71 is etched using the photoresist film as a mask, and thereafter, the photoresist film is removed. With this configuration, the conductor layer 31 and the lower electrodes 51 and 52 are formed.

When a semiconductor circuit is formed on and above the upper surface of the semiconductor substrate 21, for example, the conductor film 71 is patterned simultaneously with the patterning of the lower electrodes 51 and 52 or the like to form a gate electrode of the MOS transistor of the semiconductor circuit.

### Step of Forming Sacrificial Layer

Next, as shown in FIG. 4A, a sacrificial layer 72 is formed on the lower electrode 51. In the embodiment, the sacrificial layer 72 is formed over the entire region other than a portion (portion at which the fixed portion 532 is formed) on the lower electrode 52. In the sacrificial layer 72, an opening 721 is formed corresponding to the portion at which the fixed portion 532 is formed.

In the embodiment, the sacrificial layer 72 is a silicon oxide film, a portion of which is removed in a later-described step and the remaining portion of which serves as the insulating layer 32. When the insulating layer 32 is omitted, the sacrificial layer 72 may be formed so as to cover only the lower electrode 51. Moreover, the sacrificial layer 72 may be composed of PSG (phosphorus-doped glass) or the like.

A forming method of the sacrificial layer 72 is not particularly limited, and, for example, a sputtering method, a CVD method, or the like can be used.

### Step of Forming Movable Electrode Forming Film

Next, as shown in FIG. 4B, a conductor film 73 (movable electrode forming film) for forming the upper electrode 53 is formed in the opening 721 and on the sacrificial layer 72.

Specifically, for example, polycrystalline silicon or amorphous silicon is deposited in the opening 721 and on the sacrificial layer 72 by a sputtering method, a CVD method, or the like to forma silicon film, and thereafter, the silicon film is doped with an impurity such as phosphorus to thereby form the conductor film 73. Depending on the configuration of the sacrificial layer 72, an epitaxially grown silicon film may be doped with an impurity such as phosphorus to thereby form the conductor film 73. Moreover, the silicon film may be planarized by etch back, CMP (chemical mechanical polishing), or the like.

### Step of Forming Reinforcing Portion

Next, as shown in FIG. 4C, through-holes 731 and 732 are formed in the conductor film 73.

A forming method of the through-holes 731 and 732 is not particularly limited, but, for example, dry etching can be used. In dry etching, a resist film using photolithography can be used as a mask.

Next, the reinforcing portions 541 and 542 are formed by filling the through-holes 731 and 732 with a metal as shown in FIG. 4D.

Specifically, for example, a metal such as tungsten is deposited in the through-holes 731 and 732 and on the conductor film 73 by a sputtering method, a CVD method, or the like to form a metal film, and thereafter, an unwanted portion of the metal film other than that in the through-holes 731 and 732 is removed by etch back, CMP, or the like to leave the metal only in the through-holes 731 and 732. With this configuration, the reinforcing portions 541 and 542 can be formed. In the formation of the metal film, a metal may be deposited a plurality of times. In this case, in the first or second deposition of the metal, a glue layer may be formed using titanium, titanium nitride, or the like as a metal.

Next, as shown in FIG. 4E, the conductor film 73 is patterned to form the upper electrode 53.

Specifically, for example, a photoresist is applied on the conductor film 73 and patterned into the shape (plan-view shape) of the upper electrode 53 to form a photoresist film. Then, the conductor film 73 is etched using the photoresist film as a mask, and thereafter, the photoresist film is removed. With this configuration, the upper electrode 53 is formed.

In the manner described above, the vibrating element 5 including the lower electrodes 51 and 52 and the upper electrode 53 is formed.

### Cavity Forming Step

As shown in FIG. 5A, inter-layer insulating films 74 and 75, the wiring layers 62 and 64, and the surface protective film 65 are formed on the upper side of the vibrating element 5 and the sacrificial layer 72.

Specifically, for example, a silicon oxide film is formed on the vibrating element 5 and the sacrificial layer 72 by a sputtering method, a CVD method, or the like, and the silicon oxide film is patterned by etching, to thereby form the inter-layer insulating film 74 in which a through-hole having a shape corresponding to the wiring layer 62 is formed. Then, a film made of aluminum is formed on the inter-layer insulating film 74 by a sputtering method, a CVD method, or the like so as to fill the through-hole of the inter-layer insulating film 74, and the film is patterned (an unwanted portion is removed) by etching, to thereby form the wiring layer 62.

Thereafter, the inter-layer insulating film 75 is formed in the same manner as the inter-layer insulating film 74, and then, the wiring layer 64 is formed in the same manner as the wiring layer 62. After forming the wiring layer 64, the surface protective film 65 such as a silicon oxide film, a silicon nitride film, a polyimide film, or epoxy resin is formed by a sputtering method, a CVD method, or the like.

The stacked structure of the inter-layer insulating film and the wiring layer is formed by a common CMOS process, and the number of stacked layers is appropriately set as necessary. That is, more wiring layers may be stacked as necessary via an inter-layer insulating film. Moreover, when a semiconductor circuit is formed on and above the upper surface of the semiconductor substrate 21, a wiring layer electrically connected to the gate electrode or the like of the MOS transistor of the semiconductor circuit is formed simultaneously with, for example, the formation of the wiring layers 62 and 64.

### Step of Etching Sacrificial Layer

Next, as shown in FIG. 5B, portions of the sacrificial layer 72 and the inter-layer insulating films 74 and 75 are removed, whereby the cavity S and the inter-layer insulating films 61 and 63 are formed.

Specifically, the sacrificial layer 72 and the inter-layer insulating films 74 and 75 that are located around the vibrating element 5 and between the lower electrode 51 and the movable portion 531 are removed by etching through the plurality of fine pores 642 formed in the covering layer 641. With this configuration, the cavity S in which the vibrating element 5 is accommodated is formed, and at the same time, a gap is formed between the lower electrode 51 and the movable portion 531, so that the vibrating element 5 is brought into a state where the vibrating element 5 can be driven.

Here, the removal (release step) of the inter-layer insulating films 74 and 75 and the sacrificial layer 72 can be carried out by, for example, wet etching in which hydrofluoric acid, buffered hydrofluoric acid, or the like is supplied as an etchant through the plurality of fine pores 642, or dry etching in which hydrofluoric acid gas or the like is supplied as an etching gas through the plurality of fine pores 642. At this time, the insulating film 23 and the wiring layers 62 and 64 have resistance to the etching implemented in the release step, and function as so-called etching stop layers. Before etching, a protective film may be formed as necessary from a photoresist or the like on an outer surface of a structure including an etching target portion.

Next, as shown in FIG. 5C, the sealing layer 66 is formed on the covering layer 641.

Specifically, for example, the sealing layer 66 composed of a silicon oxide film, a silicon nitride film, a metal film such as Al, Cu, W, Ti, or TiN, or the like is formed by a sputtering method, a CVD method, or the like to seal the fine pores 642.

Through the steps described above, the MEMS structure 1 can be manufactured.

### Second Embodiment

Next, a second embodiment of the invention will be described.

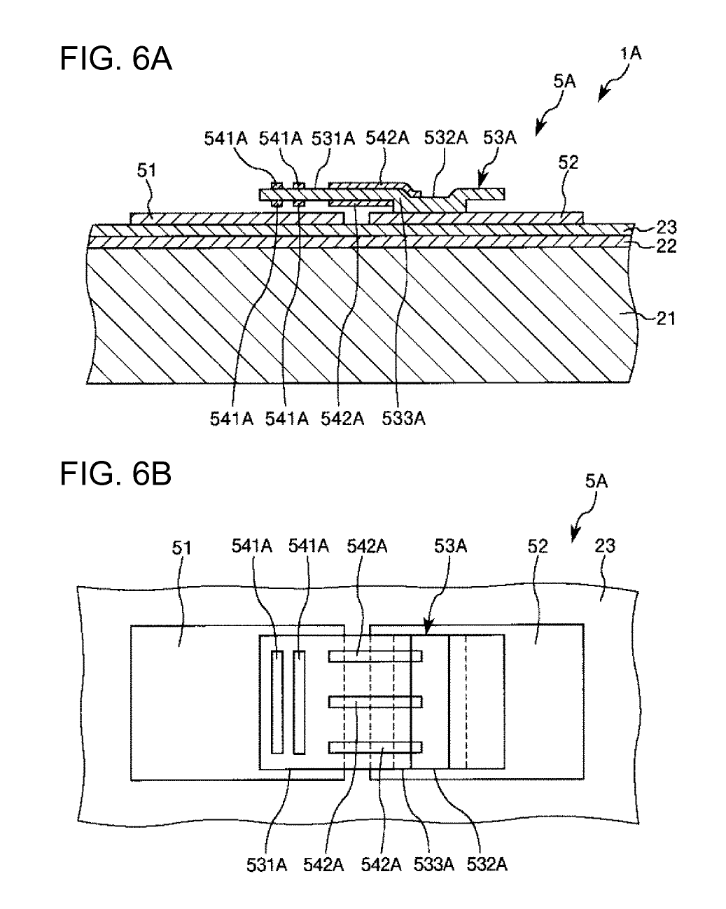

FIGS. 6A and 6B show a vibrating element included in a MEMS structure according to the second embodiment of the invention, in which FIG. 6A is a cross-sectional view, and FIG. 6B is a plan view.

Hereinafter, the second embodiment of the invention will be described, in which differences from the embodiment described above are mainly described, and similar matters are not described.

The second embodiment is similar to the first embodiment, except that the configuration of the reinforcing portion is different.

The MEMS structure 1A shown in FIGS. 6A and 6B includes a vibrating element 5A. The vibrating element 5A includes the pair of lower electrodes 51 and 52 and an upper electrode 53A supported to the lower electrode 52. The upper electrode 53A (movable electrode) includes a movable portion 531A facing and spaced from the lower electrode 51, a fixed portion 532A provided on the lower electrode 52, and a coupling portion 533A coupling the movable portion 531A with the fixed portion 532A.

As shown in FIG. 6A, a plurality of reinforcing portions 541A and a plurality of reinforcing portions 542A are disposed on each of both surfaces of the upper electrode 53A. With this configuration, the reinforcing portions 541A and 542A can be symmetrically disposed in the thickness direction of the upper electrode 53A. Therefore, it is possible to prevent or reduce the deflection of the upper electrode 53A because of a difference in thermal expansion coefficient between the reinforcing portions 541A and 542A and the upper electrode 53A. Moreover, the reinforcing portions 541A and 542A can be disposed so as to cancel out stresses of one surface and the other surface of the upper electrode 53A. Moreover, the resonant frequency of a vibrating system including the movable portion 531A can be relatively simply adjusted by removing portions of the reinforcing portions 541A and 542A as necessary by a laser or the like. That is, the reinforcing portions 541A and 542A (particularly the reinforcing portions 541A and 542A on the side opposite to the lower electrode 51) can be used also as adjusting portions to adjust the resonant frequency of the vibrating system.

In the embodiment, the reinforcing portions 541A and 542A disposed on one surface side of the upper electrode 53A and the reinforcing portions 541A and 542A disposed on the other surface side of the upper electrode 53A are disposed so as to be symmetrical about the upper electrode 53A. The arrangement of the reinforcing portions 541A and 542A may be asymmetrical about the upper electrode 53A.

Also with the reinforcing portions 541A and 542A, it is possible to reinforce the upper electrode 53A and increase the rigidity of the upper electrode 53A.

### Third Embodiment

Next, a third embodiment of the invention will be described.

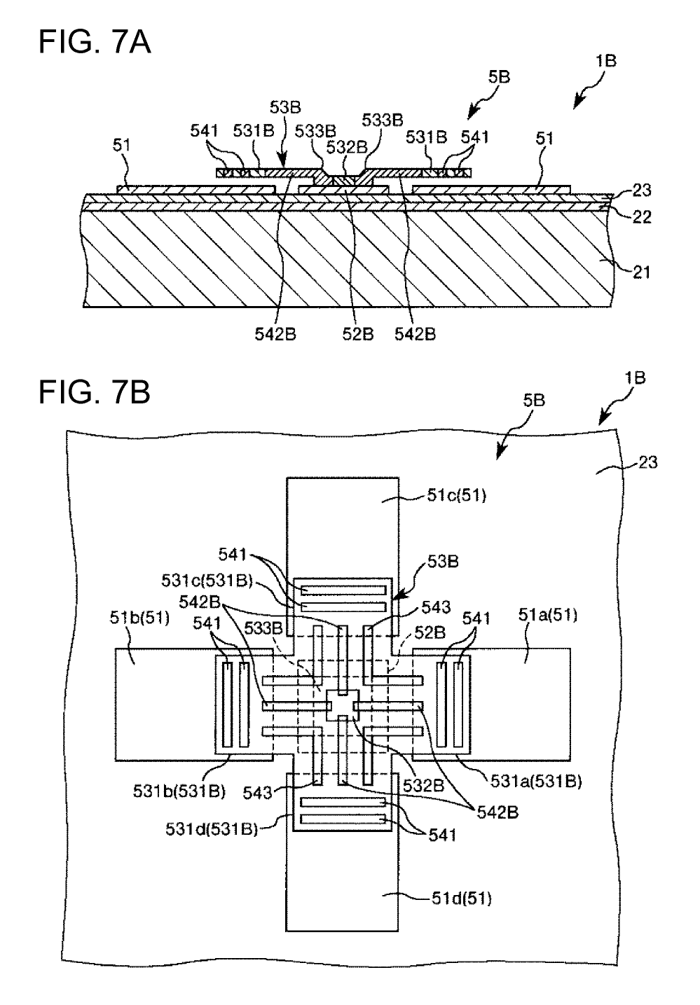

FIGS. 7A and 7B show a vibrating element included in a MEMS structure according to the third embodiment of the invention, in which FIG. 7A is a cross-sectional view, and FIG. 7B is a plan view.

Hereinafter, the third embodiment of the invention will be described, in which differences from the embodiments described above are mainly described, and similar matters are not described.

The third embodiment is similar to the first embodiment, except that the numbers of movable electrodes and fixed electrodes are different.

The MEMS structure 1B shown in FIGS. 7A and 7B includes a vibrating element 5B. The vibrating element 5B includes four lower electrode 51, a lower electrode 52B, and an upper electrode 53B supported to the lower electrode 52B.

The four lower electrodes 51 (fixed electrodes) include two lower electrodes 51a and 51b arranged in parallel, with the lower electrode 52B interposed therebetween, along a first direction (the left-and-right direction in FIG. 7B) in the plan view, and two lower electrodes 51c and 51d arranged in parallel, with the lower electrode 52B interposed therebetween, along a second direction (the up-and-down direction in FIG. 7B) orthogonal to the first direction. Moreover, each of the four lower electrodes 51 is disposed spaced from the lower electrode 52B in the plan view.

The two lower electrodes 51a and 51b are configured such that the electrodes are electrically connected to each other via a wire (not shown) to be at the same potential. Similarly, the two lower electrodes 51c and 51d are configured such that the electrodes are electrically connected to each other via a wire (not shown) to be at the same potential.

The upper electrode 53B (movable electrode) includes four movable portions 531B, a fixed portion 532B fixed to the lower electrode 52B, and a coupling portion 533B coupling the movable portions 531B with the fixed portion 532B.

The four movable portions 531B are provided corresponding to the four lower electrodes 51. Each of the movable portions 531B faces and is spaced from the corresponding lower electrode 51. That is, the four movable portions 531B include two movable portions 531a and 531b arranged in parallel, with the fixed portion 532B interposed therebetween, along the first direction (the left-and-right direction in FIG. 7B), and two movable portions 531c and 531d arranged in parallel, with the fixed portion 532B interposed therebetween, along the second direction (the up-and-down direction in FIG. 7B) orthogonal to the first direction.

The plurality of reinforcing portions 541 and a plurality of reinforcing portions 542B and 543 are disposed in each of the movable portions 531B of the upper electrode 53B.

In the MEMS structure 1B configured as described above, a periodically changing first voltage (alternating voltage) is applied between the lower electrodes 51a and 51b and the upper electrode 53B, and at the same time, a second voltage similar to the first voltage except that the phase is shifted by 180° is applied between the lower electrodes 51c and 51d and the upper electrode 53B.

Then, the movable portions 531a and 531b flexurally vibrate while being displaced alternately in directions toward and away from the lower electrodes 51a and 51b, and at the same time, the movable portions 531c and 531d flexurally vibrate, in opposite phase to the movable portions 531a and 531b, while being displaced alternately in directions toward and away from the lower electrodes 51c and 51d. That is, when the movable portions 531a and 531b are displaced in the direction toward the lower electrodes 51a and 51b, the movable portions 531c and 531d are displaced in the direction away from the lower electrodes 51c and 51d; while when the movable portions 531a and 531b are displaced in the direction away from the lower electrodes 51a and 51b, the movable portions 531c and 531d are displaced in the direction toward the lower electrodes 51c and 51d.

By vibrating the movable portions 531a and 531b and the movable portions 531c and 531d in opposite phase as described above, vibrations transmitted from the movable portions 531a and 531b to the fixed portion 532B and vibrations transmitted from the movable portions 531c and 531d to the fixed portion 532B can be canceled out each other. As a result, leaking of these vibrations to the outside via the fixed portion 532B, so-called vibration leakage, can be reduced, so that vibration efficiency of the MEMS structure 1B can be increased. As described above, since the number of movable portions 531B is more than one in the MEMS structure 1B, vibration leakage from the movable portions 531B to the outside can be reduced.

### Fourth Embodiment

Next, a fourth embodiment of the invention will be described.

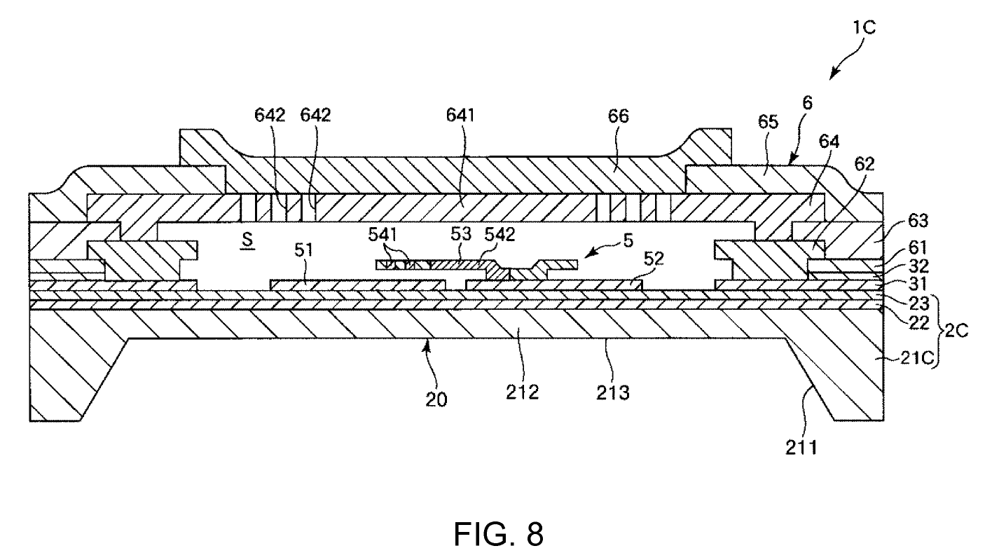

FIG. 8 is a cross-sectional view showing a MEMS structure according to the fourth embodiment of the invention.

Hereinafter, the fourth embodiment of the invention will be described, in which differences from the embodiments described above are mainly described, and similar matters are not described.

The fourth embodiment is similar to the first embodiment, except that the fourth embodiment includes a diaphragm portion.

The MEMS structure 1C shown in FIG. 8 is configured to be able to detect pressure. The MEMS structure 1C includes a substrate 2C including a diaphragm portion 20, instead of the substrate 2 in the MEMS structure 1 of the first embodiment.

The substrate 2C includes a semiconductor substrate 21C, the insulating film 22 provided on one of surfaces of the semiconductor substrate 21C, and the insulating film 23 provided on the insulating film 22.

The substrate 2C is provided with the diaphragm portion 20, which is thinner than the peripheral portion and deflected and deformed under pressure. The diaphragm portion 20 is formed by providing a bottomed recess 211 in a lower surface of the semiconductor substrate 21C. A lower surface of the diaphragm portion 20 is a pressure receiving surface 213. The recess 211 can be formed by etching.

In the substrate 2C of the embodiment, the recess 211 does not penetrate the semiconductor substrate 21C, and the diaphragm portion 20 is composed of three layers of a thin portion 212 of the semiconductor substrate 21C, the insulating film 22, and the insulating film 23.

The vibrating element 5 is provided on a surface of the diaphragm portion 20 on the side opposite to the pressure receiving surface 213. In the embodiment, the vibrating element 5 is disposed at the central portion of the diaphragm portion 20 in the plan view.

The cavity S in which the vibrating element 5 is accommodated functions as a pressure reference chamber serving to provide a reference value of the pressure detected by the MEMS structure 1C. By bringing the cavity S into the vacuum state, the MEMS structure 1C can be used as an “absolute pressure sensor” that detects pressure with the vacuum state as a reference, so that the convenience of the MEMS structure is improved.

In the MEMS structure 1C configured as described above, when pressure is applied to the pressure receiving surface 213, the diaphragm portion 20 is deflected and deformed toward the cavity S side. With the deformation, the gap (spaced distance) between the movable portion 531 of the upper electrode 53 and the lower electrode 51 changes.

When the gap between the movable portion 531 of the upper electrode 53 and the lower electrode 51 changes, the resonant frequency of a vibrating system composed of the lower electrode 51 and the upper electrode 53 changes. Therefore, based on the change in resonant frequency, the magnitude of the pressure (absolute pressure) received by the pressure receiving surface 213 can be obtained.

### 2. Electronic Apparatus

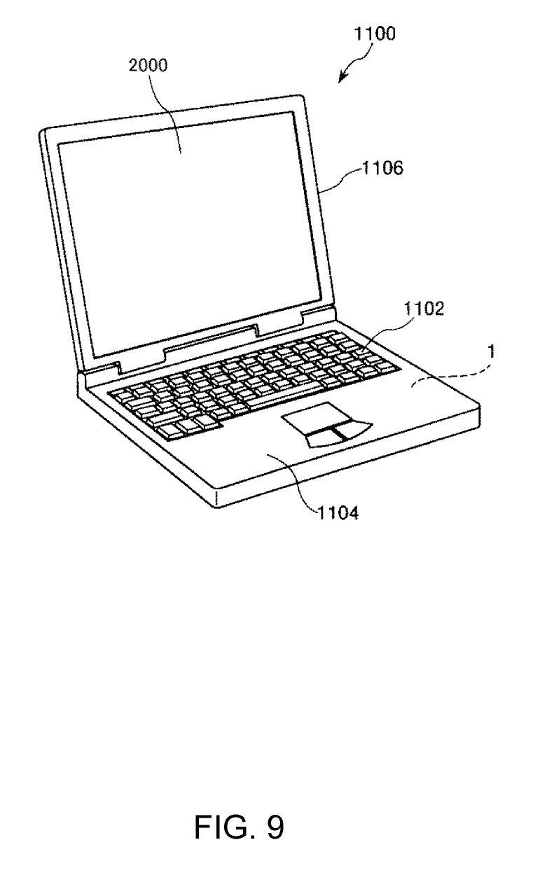

Next, an electronic apparatus (electronic apparatus according to the invention) to which the MEMS structure according to the invention is applied will be described in detail based on FIGS. 9 to 11.

FIG. 9 is a perspective view showing a configuration of a mobile (or notebook) personal computer as a first example of the electronic apparatus according to the invention. In the drawing, the personal computer 1100 is composed of a main body portion 1104 including a keyboard 1102, and a display unit 1106 including a display portion 2000. The display unit 1106 is rotatably supported to the main body portion 1104 via a hinge structure portion. Into the personal computer 1100, the MEMS structure 1 (oscillator) is built.

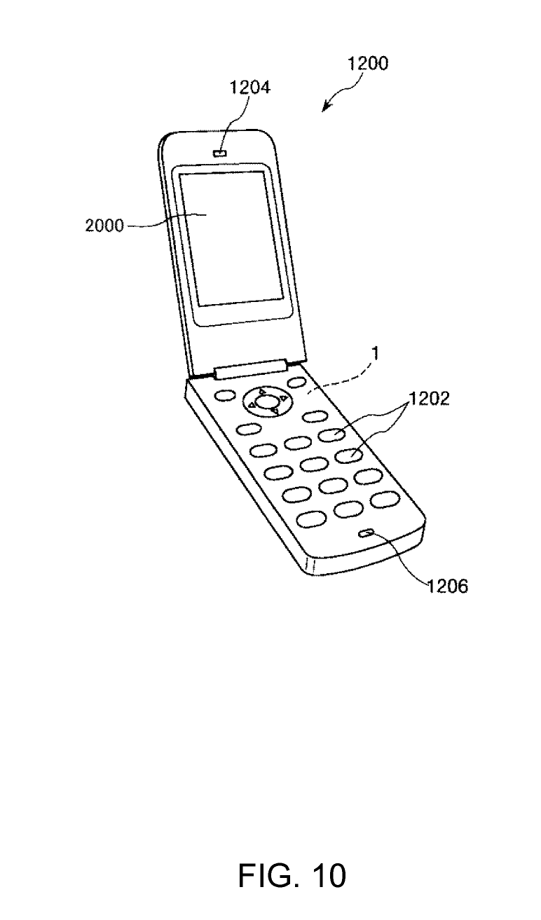

FIG. 10 is a perspective view showing a configuration of a mobile phone (including a PHS) as a second example of the electronic apparatus according to the invention. In the drawing, the mobile phone 1200 includes a plurality of operation buttons 1202, an earpiece 1204, and a mouthpiece 1206. The display portion 2000 is disposed between the operation buttons 1202 and the earpiece 1204. Into the mobile phone 1200, the MEMS structure 1 (oscillator) is built.

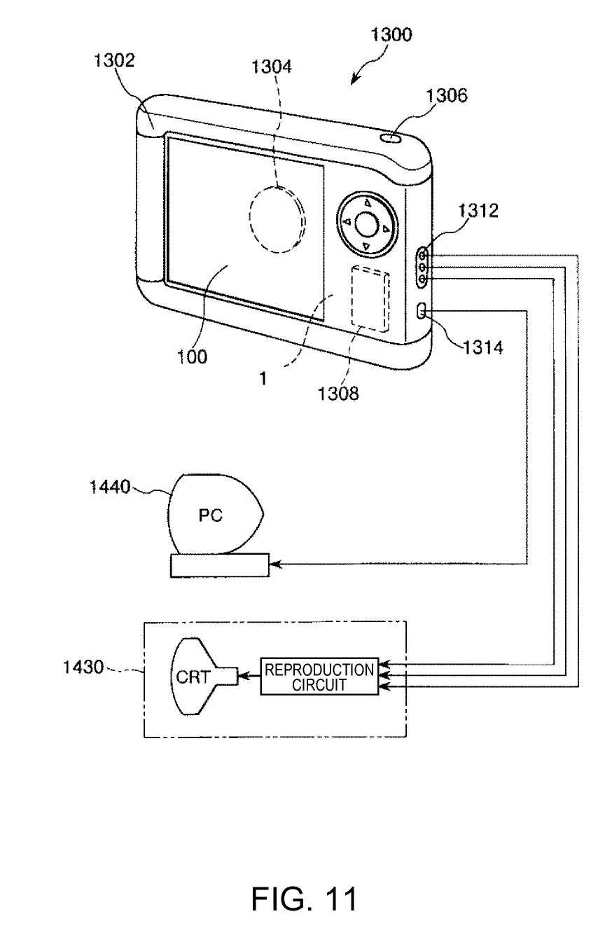

FIG. 11 is a perspective view showing a configuration of a digital still camera as a third example of the electronic apparatus according to the invention. In the drawing, connections with external apparatuses are also shown in a simplified manner. Here, usual cameras expose a silver halide photographic film with an optical image of a subject, whereas the digital still camera 1300 photoelectrically converts the optical image of the subject with an imaging device such as a CCD (Charge Coupled Device) to generate imaging signals (image signals).

A display portion is provided on a back surface of a case (body) 1302 in the digital still camera 1300 and configured to perform display based on the imaging signals generated by the CCD. The display portion functions as a finder that displays the subject as an electronic image. Moreover, on the front side (the rear side in the drawing) of the case 1302, a light receiving unit 1304 including an optical lens (imaging optical system) and the CCD is provided.

When a photographer confirms the subject image displayed on the display portion and presses down a shutter button 1306, imaging signals of the CCD at the time are transferred to and stored in a memory 1308. In the digital still camera 1300, a video signal output terminal 1312 and a data communication input/output terminal 1314 are provided on a side surface of the case 1302. Then, as shown in the drawing, a television monitor 1430 and a personal computer 1440 are connected as necessary to the video signal output terminal 1312 and the data communication input/output terminal 1314, respectively. Further, the imaging signals stored in the memory 1308 are output to the television monitor 1430 or the personal computer 1440 by a predetermined operation. Into the digital still camera 1300, the MEMS structure 1 (oscillator) is built.

The electronic apparatuses described above have excellent reliability.

In addition to the personal computer (mobile personal computer) shown in FIG. 9, the mobile phone shown in FIG. 10, and the digital still camera shown in FIG. 11, the electronic apparatus including the MEMS structure according to the invention can be applied to, for example, inkjet ejection apparatuses (e.g., inkjet printers), laptop personal computers, television sets, video camcorders, video tape recorders, car navigation systems, pagers, electronic notebooks (including those with communication function), electronic dictionaries, calculators, electronic gaming machines, word processors, workstations, videophones, surveillance television monitors, electronic binoculars, POS terminals, medical apparatuses (e.g., electronic thermometers, sphygmomanometers, blood glucose meters, electrocardiogram measuring systems, ultrasonic diagnosis apparatuses, and electronic endoscopes), fishfinders, various types of measuring instrument, indicators (e.g., indicators used in vehicles, aircraft, and ships), and flight simulators.

### 3. Moving Object

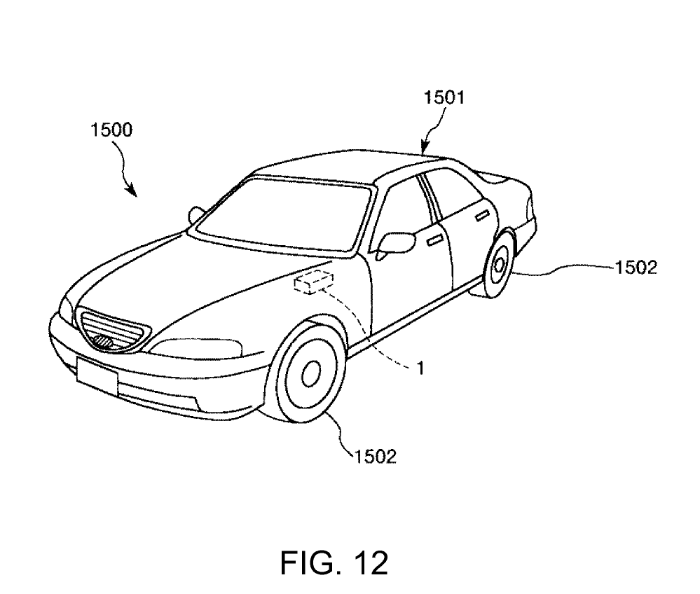

FIG. 12 is a perspective view showing a configuration of an automobile as an example of a moving object according to the invention.

In the drawing, a moving object 1500 includes a car body 1501 and four wheels 1502, and is configured to rotate the wheels 1502 with a power source (engine) (not shown) provided in the car body 1501. Into the moving object 1500, the MEMS structure 1 is built.

The moving object described above has excellent reliability. The moving object according to the invention is not limited to an automobile, and can be applied to, for example, various types of moving objects such as aircraft, ships, and motorcycles.

The MEMS structure, the electronic apparatus, and the moving object according to the invention have been described above based on the embodiments shown in the drawings, but the invention is not limited to the embodiments. The configuration of each part can be replaced with any configuration having a similar function. Moreover, any other configurations may be added to the embodiments.

For example, in the embodiments, the number of the reinforcing portions 541 is two, and the number of the reinforcing portions 542 is three. However, the invention is not limited to these numbers. The number of the reinforcing portions 541 may be one, or three or more, and the number of the reinforcing portions 542 may be one, two, or four or more.

Moreover, in the embodiments, the plurality of reinforcing portions 541 are formed equal in length to each other, and the plurality of reinforcing portions 542 are formed equal in length to each other. However, the lengths of the plurality of reinforcing portions 541 may be different from each other, and the lengths of the plurality of reinforcing portions 542 may be different from each other.

Moreover, in the embodiments, each of the reinforcing portions 541 and 542 has a linearly extending shape. However, the shape of each of the reinforcing portions 541 and 542 is not limited to this shape. For example, at least one of the reinforcing portions 541 may have a bent or curved portion.

Moreover, in the embodiments, the reinforcing portion 541 and the reinforcing portion 542 are disposed spaced from each other. However, the reinforcing portion 541 and the reinforcing portion 542 may be integrally formed. For example, the reinforcing portion may be composed of one structure including a portion extending in the length direction of the movable portion 531 and a portion extending in the width direction.

Moreover, in the embodiments, a description has been given of the case where the area of the fixed electrode in the plan view is larger than the area of the movable portion of the movable electrode. However, the area of the fixed electrode in the plan view may be the same as or smaller than the area of the movable portion of the movable electrode.

Moreover, in the embodiments, a description has been given of the configuration in which the movable portion of the vibrating element is supported in a cantilever fashion. However, the invention is not limited to the configuration, and the movable portion may be fixed at both ends. Moreover, the numbers of fixed portions and coupling portions may be more than one. Moreover, the coupling portion coupling the movable portion with the fixed portion may have a longitudinal shape like a beam. The vibration mode of the movable portion is not limited only to flexural vibration as in the embodiments, but various vibration modes can be realized by appropriately changing the shapes of the movable portion and the coupling portion, the direction of a driving force acting on the movable portion, or the like.

Moreover, in the embodiments, a description has been given of an example in which the reinforcing portion extending in the length direction of the movable portion and the reinforcing portion extending in the width direction of the movable portion are both provided. However, the reinforcing portion extending in any of the directions may be omitted.

Moreover, the reinforcing portion may include a portion extending along a direction inclined to the length direction or the width direction of the movable portion, or may have a sheet-like shape extending along the plate surface of the movable portion.

Moreover, in the embodiments, a description has been given of an example in which the fixed electrode and the movable electrode are formed by deposition. However, the invention is not limited to the example. For example, the fixed electrode or the movable electrode may be formed by etching a substrate.

The entire disclosure of Japanese Patent Application No. 2014-108378, filed May 26, 2014 is expressly incorporated by reference herein.

What is claimed is:

1. A MEMS structure comprising:
a substrate;
a fixed electrode disposed above the substrate;
a movable electrode including a movable portion disposed facing and spaced from the fixed electrode; and
a reinforcing portion disposed in the movable electrode so as to extend along an extending direction of the movable portion, the reinforcing portion including a material having a higher Young's modulus than the movable electrode.

2. The MEMS structure according to claim 1, wherein the reinforcing portion includes a portion extending along a width direction of the movable portion.

3. The MEMS structure according to claim 1, wherein the movable electrode includes a fixed portion connected to the movable portion and fixed to the substrate, and
the reinforcing portion includes a portion extending along a direction in which the movable portion and the fixed portion are arranged in parallel in a plan view.

4. The MEMS structure according to claim 1, wherein the movable electrode includes a fixed portion connected to the movable portion and fixed on the substrate, and
the reinforcing portion includes a portion disposed so as to connect the movable portion with the fixed portion.

5. The MEMS structure according to claim 1, wherein the reinforcing portion includes a metal.

6. The MEMS structure according to claim 5, wherein the metal includes tungsten.

7. The MEMS structure according to claim 1, wherein the reinforcing portion penetrates the movable electrode in a thickness direction thereof.

8. The MEMS structure according to claim 1, wherein the reinforcing portion is disposed on each of both surfaces of the movable electrode.

9. The MEMS structure according to claim 1, wherein the number of the movable portions is more than one.

10. An electronic apparatus comprising the MEMS structure according to claim 1.

11. A moving object comprising the MEMS structure according to claim 1.
